(19) United States
(12) Patent Application Publication
(10) Pub. No.: US 2011/0116648 A1
(43) Pub. Date: May 19, 2011

(54) PREVENTION OF HEARING LOSS FROM AUDIO DEVICES

(76) Inventor: Samuel C. HARWELL, Austin, TX (US)

(21) Appl. No.: 12/619,372

(22) Filed: Nov. 16, 2009

(51) Int. Cl. H04R 1/10

(52) U.S. Cl. 381/74

(57) ABSTRACT

An audio device with means for preventing hearing loss. The audio device includes an audio source for providing an audio signal to headphones, and an audio component for determining an equivalent sound level of the audio signal and attenuating the audio signal to limit acoustic energy output from the headphones based on the determined equivalent sound level.

### BACKGROUND

### Field

The disclosure relates generally to the audio devices, and more specifically to the prevention of hearing loss from audio devices.

### INTRODUCTION

Personal audio devices, such as digital audio players (e.g., MP3 players), compact disc players, cassette tape players, and radios (e.g., AM/FM radios, digital radios, satellite radios, GPS radios, etc.), have become increasingly popular with consumers wishing to have portable audio entertainment. Typically, the devices are small and lightweight, and are carried by a user in one hand, or are attached to the user's clothing, or strapped to a user's body. Such devices are frequently used by joggers, bikers, bicyclists, travelers, students, office workers, and anyone else who desires to enjoy personal audio entertainment with personal mobility.

Headphones are often used with these devices to prevent other people from hearing the audio, either for privacy or to prevent disturbance, such as listening in a public library. Headphones can also provide a level of sound quality greater than loudspeakers of similar cost. Although these benefits may contribute to the enjoyment of the audio experience for the user, manufacturers of portable audio devices have not yet taken adequate steps to protect the long-term hearing of headphone users. It is well known that noise-induced hearing loss can occur as a result of repeated exposure to loud sound over time. The louder the volume, the less time required before hearing may be impaired.

Unfortunately, users are not given any way to monitor the level of sound delivered by the headphones, so they have no way of knowing when their hearing may be affected. Accordingly, there is a need in the art for improved audio devices with a means to prevent hearing loss.

### SUMMARY

In one aspect of the disclosure, an audio device includes an audio source for providing an audio signal to headphones, and an audio component for determining an equivalent sound level of the audio signal and attenuating the audio signal to limit acoustic energy output from the headphones based on the determined equivalent sound level.

In another aspect of the disclosure, an audio device includes means for providing an audio signal to headphones, means for determining an equivalent sound level of the audio signal, and means for attenuating the audio signal to limit acoustic energy output from the headphones based on the determined equivalent sound level.

In yet another aspect of the disclosure, a machine-readable medium instructions executable by a processor, the instructions including code for providing an audio signal to headphones, determining an equivalent sound level of the audio signal, and attenuating the audio signal to limit acoustic energy output from the headphones based on the determined equivalent sound level.

It is understood that other aspects of the invention will become readily apparent to those skilled in the art from the following detailed description, wherein various aspects of the invention are shown and described by way of illustration. As will be realized, the invention is capable of other and different configurations and implementations and its several details are capable of modification in various other respects, all without departing from the scope of this invention. Accordingly, the drawings and detailed description are to be regarded as illustrative in nature and not as restrictive.

### BRIEF DESCRIPTION OF THE DRAWINGS

Various aspects of an audio device are illustrated by way of example, and not by way of limitation, in the accompanying drawings, wherein:

FIG. 1 is a conceptual diagram of an embodiment of an audio device;

FIG. 2 is a conceptual diagram of an embodiment of an audio device with a means to prevent hearing loss;

FIG. 3 is a conceptual diagram of another embodiment of an audio device with a means to prevent hearing loss;

FIG. 4 is a conceptual diagram illustrating an example of the hardware configuration of an audio device; and

FIG. 5 is a flow chart illustrating an example of an algorithm for limiting the audio sound level from headphones.

### DETAILED DESCRIPTION

The detailed description set forth below in connection with the appended drawings is intended as a description of various embodiments of the present invention. The invention, however, may be embodied in many different forms and should not be construed as limited to the various concepts presented throughout this disclosure. Rather, these concepts are provided so that this disclosure will be thorough and complete, and will fully convey the scope of the present invention to those skilled in the art. The detailed description includes specific details for the purpose of providing a thorough understanding of the invention. However, it will be apparent to those skilled in the art that the invention may be practiced without these specific details. In some instances, well-known structures and components are omitted in order to avoid obscuring the concepts of the invention.

Various concepts will now be presented with reference to a portable audio device, such as a digital audio player (e.g., MP3 players), a compact disc player, a cassette tape player, a radio (e.g., an AM/FM radio, a digital radio, a satellite radio, a GPS radio, etc.), or other similar device. However, as those skilled in the art will readily appreciate, these concepts may be extended to other devices that deliver audio regardless of whether such devices are portable, and regardless of whether such devices are used with headphones. By way of example, various concepts presented throughout this disclosure may be extended to cellular telephones, personal digital assistants (PDA), personal and laptop computers, handheld game consoles, handheld multimedia devices, home entertainment products (e.g., televisions, DVD players, CD players, stereo radios, etc.), or any other suitable device capable of providing audio to a user. Accordingly, any reference to a specific audio device is intended only to illustrate various aspects of the present invention, with the understanding that these aspects have a wide range of applications

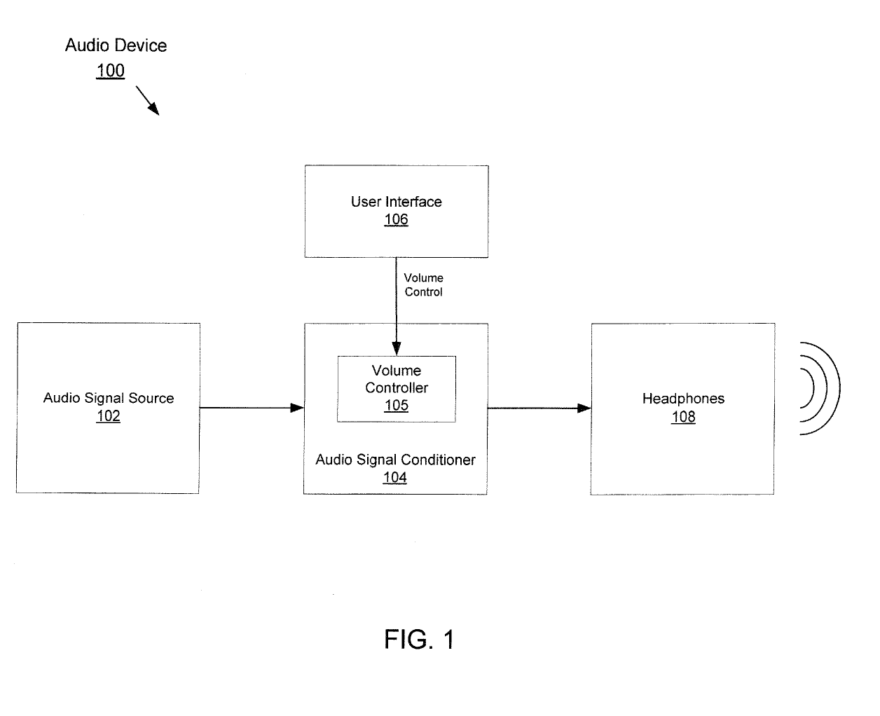

FIG. 1 is a conceptual diagram of an embodiment of an audio device. The audio device 100 includes four fundamental components: an audio signal source 102, and audio signal conditioner 104, a user interface 106, and headphones 108. In one embodiment of an audio device 100, the audio signal source 102 is the means by which an audio signal is provided to the headphones. It retrieves compressed audio files (e.g., MP3 files) from memory and decompresses them using an appropriate file format decoding scheme. The decompressed audio signal is then conditioned by the audio signal conditioner 104 before being provided to the headphones 108 to covert the audio signal into sound waves that can be heard by the user.

In this embodiment, the audio device 100 is a digital audio player (e.g., an MP3 player). However, in other embodiments of the audio device 100, the audio signal source 102 may be a CD drive for converting information recorded on a CD into an audio signal, an FM/AM, digital, satellite, or GPS receiver for receiving an over-the-air audio signal broadcast, a modem for receiving an audio signal broadcast, multicast, or unicast over a wired (e.g., Ethernet, cable modem, DSL, fiber optic, PSTN twisted pair, etc.) or wireless (e.g., cellular, IEEE 802.11, Bluetooth, etc.) network, or some other audio signal source suitable for the particular application.

The audio signal conditioner 104 may be used to condition the audio signal from the audio signal source 102 by providing amplification, filtering, equalization, volume control, tone control, and/or other signal conditioning functions. These functions may be performed in the digital domain, as frequently is the case with portable digital audio players, and then converted to the analog domain with a D/A converter (not shown) before being provided to the headphones 108. Alternatively, the functionality of the audio signal conditioner 104, or portion thereof, may be performed in the analog domain. A volume controller 105 provides a means for adjusting the volume of the audio signal in response to a volume control signal from the user interface 106. The volume controller 105 is shown as part of the audio signal conditioner 104, by may be implemented apart from the audio signal condition or distributed across multiple entities in the audio device 100 including the audio signal condition 104.

The term “headphones” is to be construed broadly to include one or more electroacoustic transducers designed to be used in close proximity of a user's ear regardless of nomenclature, including earphones, earbuds, stereophones, headsets, cans, and other electroacoustic transducers. In the context of telecommunications, a headset is often used to describe a combination of a headphone and microphone used for two-way communication, by way of example, with a cellular telephone.

Various concepts will now be presented for preventing hearing loss from audio devices. These concepts are particularly well suited for audio devices designed for headphones, but may also be extended to audio devices designed for any type of loudspeaker. These concepts are based on the response of the headphones to an audio signal in terms of acoustic energy. If the audio device is aware of this response, then a measurement of the voltage at the output of the audio signal conditioner may be used to limit the acoustic energy output from the headphones to a level that prevents the loss of hearing. More precisely, the audio device may be configured to use information representative of the headphones' response to progressively limit the gain of the volume controller to keep the equivalent sound level (L_{eq}) down at a safe level. When the L_{eq} is used to limit the gain instead of clipping the audio signal, the user can listen to higher quality dynamic music, such as orchestral pieces that include a small number of very loud sections, while still protecting his or her hearing.

Various methods may be used to provide information representative of the headphones' response to an audio device. By way of example, an audio device manufacturer can measure the response of the headphones it packages with each audio device and pre-program the information into the device. As long as the user continues to use those headphones with the audio device, he or she will be protected.

Alternatively, the headphones' response may be encoded as a sequence of letters and/or numbers, and either stamped on the side of the headphones distributed in an information packet. This sequence could be entered into a compatible audio device to provide protection for whatever headphones a user decides to use.

The mass manufacturing of headphones results in a similar response for the same model. Thus, as part of the development effort, the encoded sequence for popular headphones may be provided on a public web site. With this approach, every user can be protected regardless of which headphones he or she uses.

The headphones' response may be represented by mapping the audio signal input to the sound level output. While the mapping may vary slightly from user to user, it is within a suitable error margin to use for protecting hearing. The headphones' response may be measured by placing the headphones on a dummy with synthetic tissue with the same acoustic properties of the human ear and measuring the sound level produced by carefully controlled inputs. The measurements only need to be taken once to get a close approximation, but a large manufacturing facility may want to periodically test production units to ensure continued reliability.

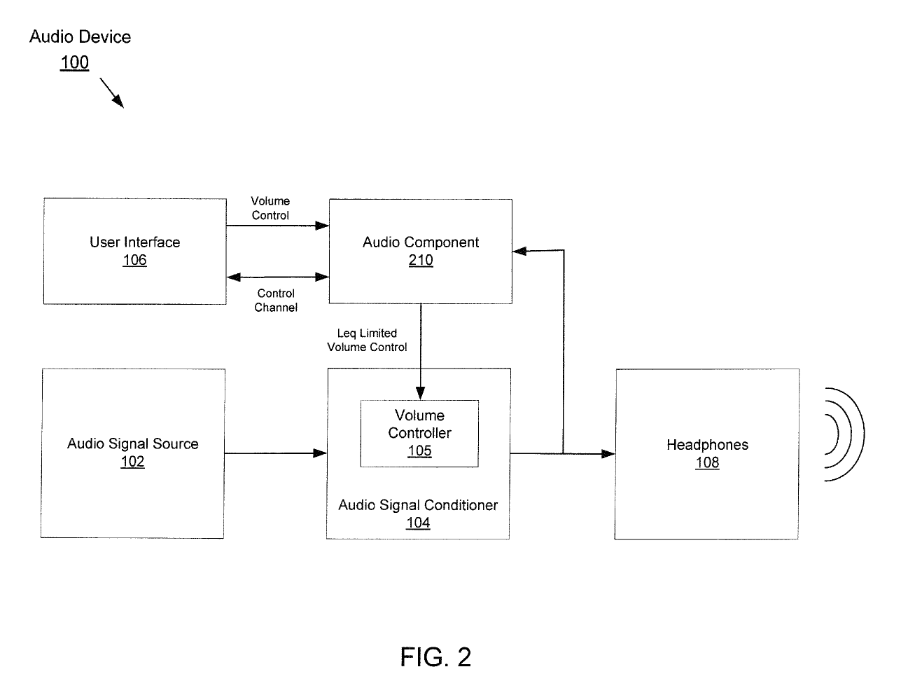

FIG. 2 is a conceptual diagram of an embodiment of an audio device with a means for preventing hearing loss. This embodiment is similar to that described in FIG. 1 in that it includes an audio signal source 102, an audio signal conditioner 104 with a volume controller 105, a user interface 106, and headphones 108. In this embodiment, the user interface 106 (e.g., a keypad) may be used to program an encoded sequence representing the headphones' response into an audio component 210 over a control channel. The audio component 210 provides a means for determining the L_{eq} by for the audio signal by continually measuring the voltage at the output from the audio signal conditioner 104 and then applying information representative of the headphones' response to determine the L_{eq}. The audio component also provides a means for attenuating the audio signal to limit the acoustic energy output from the headphones based on the L_{eq} by progressively limiting the gain of the volume controller 105 to keep the L_{eq} down at a safe level. The control channel may be used to enable the user interface 106 to provide various functions, such as indicating when the L_{eq} is too high, allowing the user to override this volume limiting function, and providing a parent the ability to lock the volume limiting function to protect their children.

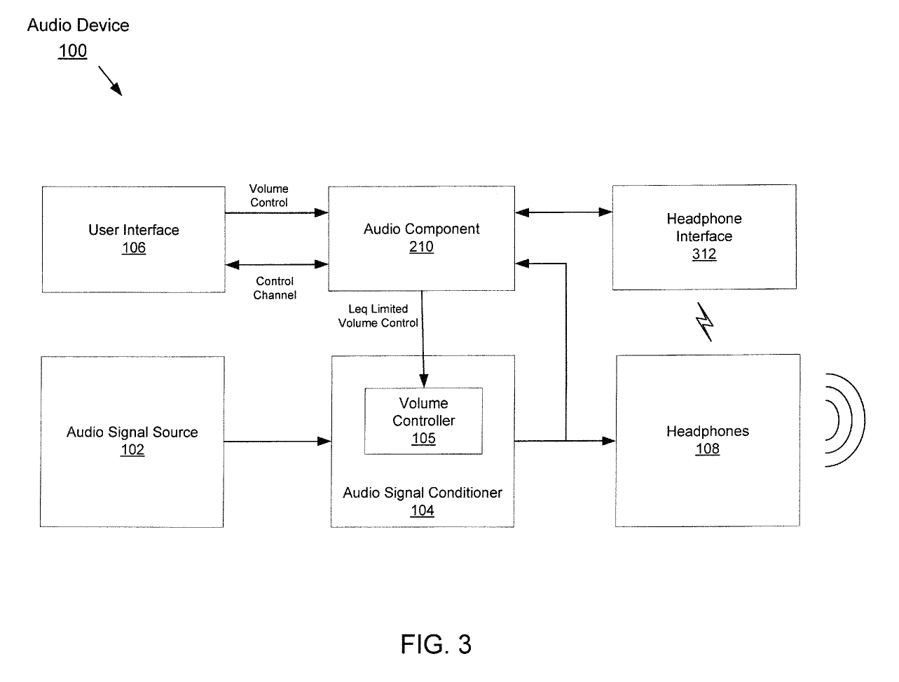

In one embodiment of an audio device, the encoded sequence representative of the headphones' response may be provided by a component inside the headphones. Turning to FIG. 3, the audio device 100 may include a headphone interface 312 that automatically queries the attached headphones for the information over a short range wireless link. By way of example, the headphones 108 may include a passive RFID tag which stores the encoded sequence. In this example, the headphone interface 312 sends a high frequency low-power transmission to the headphones 108 to read the tag. Using power from the audio device 100, the RFID transmits the encoded sequence to the headphone interface 312.

The various components of the audio device described thus far may be implemented as hardware, software, or combinations of both. Whether such components are implemented as hardware or software depends upon the particular application and design constraints imposed on the overall system. Skilled artisans may implement the described components in varying ways for each particular application. By way of example, each component, or any combination of components, may be implemented with one or more microprocessors, microcontrollers, digital signal processors (DSPs), field programmable gate arrays (FPGAs), programmable logic devices (PLDs), controllers, state machines, gated logic, discrete hardware components, or any other suitable circuits that can perform the various functionalities described throughout this disclosure, or any combination thereof.

Various components (e.g., microprocessor) may be configured to execute software. Software shall be construed broadly to mean instructions, data, or any combination thereof, whether referred to as software, firmware, middleware, microcode, hardware description language, or otherwise. The software may be stored on machine-readable media. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof.

The machine-readable media may be part of the audio device. Alternatively, any portion of the machine-readable media may be external to the audio device. By way of example, the machine-readable media may include a transmission line or a carrier wave modulated by data, all which may be accessed by the audio device.

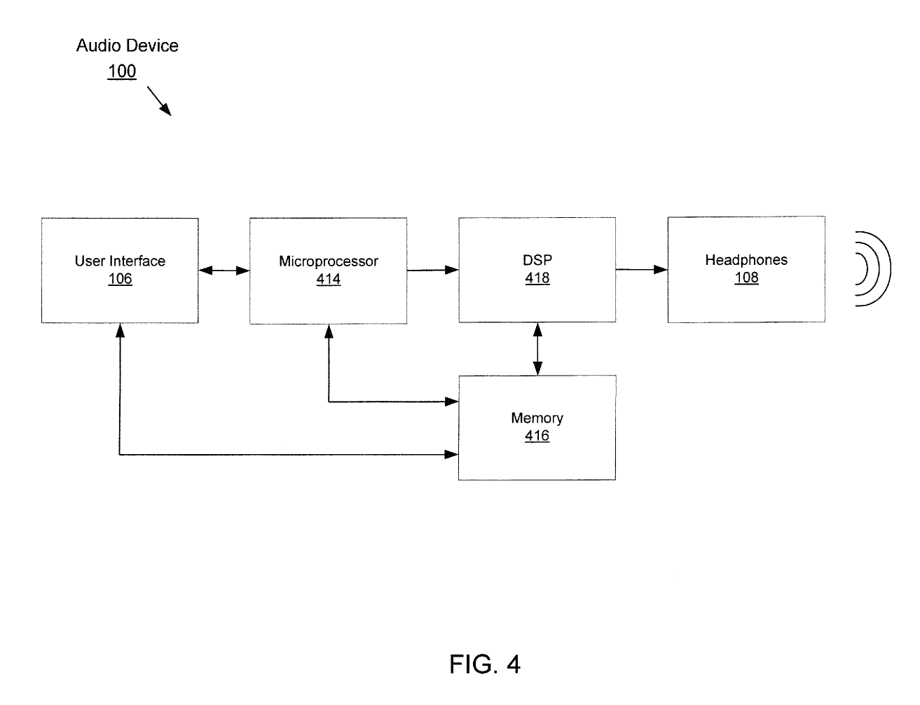

An example of a hardware implantation for an audio device will now be presented with reference to FIG. 4. In this example, the audio device is a digital audio player. The audio device 100 includes a user interface 106, a microprocessor 414, memory 416, a DSP 418, and headphones 108.

The microprocessor 414 is the brains of the audio device 100. It monitors user inputs from the user interface 106, displays information on the user interface 106, and provides directions to the DSP 418 for processing the audio signal.

The DSP 418 may be used to implement the audio signal source 102 and the audio signal conditioner 104 (see FIG. 3). The memory 416 may be used to store compressed audio files. In response to various selections made by the user on the user interface 106, the microprocessor 414 uses the DSP 418 to decompress an audio file in memory 416 via a decoding algorithm to produce an audio signal. The microprocessor 414 also allows the user to control the volume from the user interface 106 by directing the DSP 418 to adjust the gain of the audio signal. The microprocessor 414 also directs the DSP 418 to limit L_{eq} of the audio signal to a safe level. As discussed earlier, the microprocessor 414 may disable the latter feature in response to inputs from the user interface 106, implement a parental lock to prevent children from enabling this feature, and provide an indication to the user interface 106 in the event that the L_{eq} exceeds a safe level. The audio signal is then provided to a D/A converter (not shown) to produce an analog audio signal suitable for driving the headphones 108.

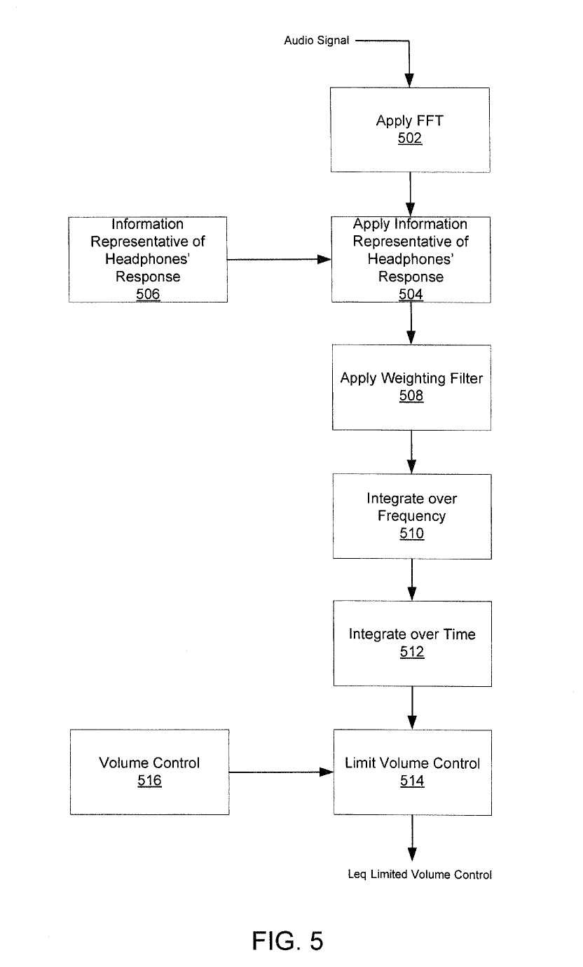

FIG. 5 is a flow chart illustrating an exemplary algorithm implemented by the DSP to limit the L_{eq} to a safe level. In this example, the algorithm is implemented in software executed by the DSP. However, this algorithm may be implemented in software running on other hardware platforms, or alternatively implemented with discrete hardware components. Those skilled in the art will readily understand how best to implement this algorithm based on the particular application and overall design constraints imposed on the overall system. Moreover, as those skilled in the art will appreciate, other algorithm may be used to limit the L_{eq} to a safe level.

The algorithm will be described by a series of steps. In this embodiment, each step represents a software component, but may be implemented in hardware or by some other means in alternative embodiments. A software component may be a process, an object, an executable, a thread of execution, a program, an application, a routine, a subroutine, a block of code, a set of instructions, a module, or any other executable software component. In this example, the software components may be embedded in the DSP and/or stored in machine-readable media. When referring to the functionality of a software component, it will be understood that such functionality is implemented by the DSP when executing the software component.

Turning to FIG. 5, the audio signal (i.e., decompressed audio file) is run through a Fast Fourier Transform (FFT) in step 502. The FFT is used to determine the electrical energy present in each frequency band in the audio spectrum.

In step 504, information representative of the headphones' response is applied audio signal to determine the acoustic energy in each frequency band. As discussed earlier, the headphones' response could be programmed into the audio device in any number of ways. The response may take the form of a response curve that maps the audio signal to the acoustic energy output from the headphones. The response curve may be stored in memory as a look-up table and provided to the audio component in step 506.

In step 508, a weighting filter is applied to the audio signal. The weighting filter reduces the contribution of low and high frequencies, which are not perceived by the human ear to be as loud as mid-frequency sounds. A-weighting is the most commonly used of a family of curves defined in the International standard IEC 61672:2003 and various national standards relating to the measurement of sound levels. The weighting filter applies a weight to the acoustic energy in each frequency band.

The weighted acoustic energy is then integrated in steps 510 and 512. In step 510, the weighted acoustic energy is integrated over frequency to produce a total instantaneous acoustic energy. In step 512, the total instantaneous acoustic energy is integrated over time to produce L_{eq}.

In step 514, the gain of the audio signal set by the DSP in step 516 in response to a volume control input at the user interface is limited by the L_{eq}. In one embodiment of an audio device, the L_{eq} may be kept below a decently sized margin of safe levels to allow for other sounds that the user may be exposed to. The exact level of the L_{eq} for any particular application may vary.

It is understood that any specific order or hierarchy of steps described in this algorithm is being presented to provide an example of an audio device. Based upon design preferences, it is understood that the specific order or hierarchy of steps may be rearranged. In addition, it is understood that any step may be omitted and/or additional steps not disclosed herein can be included, all while remaining within the scope of the invention.

Although various aspects of an audio device have been described as software implementations, those skilled in the art will readily appreciate that the various software components presented throughout this disclosure may be implemented in hardware, or any combination of software and hardware. Whether these components are implemented in hardware or software depends upon the particular application and design constraints imposed on the overall system. Skilled artisans may implement the described functionality in varying ways for each particular application, but such implementation decisions should not be interpreted as causing a departure from the scope of the invention.

Various software implementations of the present invention may allow existing audio devices to be upgraded. By way of example, a user may be able to download an application program that can be installed on the audio device and executed by the microprocessor to direct the DSP to limit the gain of the digital audio signal to a safe level based on the L_{eq}. The application program may include a database having the encoded sequence for the intensity response of the most popular headphones, which can be presented by the microprocessor to the user via the user interface. The application program can be downloaded from a public or private website or purchased from a retailer on a physical machine-readable medium (e.g., a CD).

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An audio device, comprising:
an audio source for providing an audio signal to headphones; and
an audio component for determining an equivalent sound level of the audio signal and attenuating the audio signal to limit acoustic energy output from the headphones based on the determined equivalent sound level.

2. The audio device of claim 1 further comprising a volume controller for adjusting the volume of the audio signal, wherein the audio component attenuates the audio signal by adjusting gain of the volume controller.

3. The audio device of claim 1 wherein the audio component is further configured to determine the equivalent sound level using information representative of the headphone's response.

4. The audio device of claim 3 wherein the audio component is further configured to determine the equivalent sound level by applying the information to the audio signal.

5. The audio device of claim 3 further comprising a user interface for providing the information to the audio component.

6. The audio device of claim 3 further comprising a headphone interface component for requesting the information from the headphones.

7. The audio device of claim 3 further comprising a headphone interface component for receiving the information from the headphones and providing the information to the audio component.

8. The audio device of claim 1 further comprising the headphones.

9. The audio device of claim 1 wherein the audio component is further configured to determine the equivalent sound level by applying a weighting curve to the audio signal.

10. The audio device of claim 1 further comprising a user interface for alerting a user if the determined equivalent sound level exceeds a threshold.

11. The audio device of claim 1 further comprising a user interface for disabling the audio component.

12. The audio device of claim 11 wherein the user interface is further configured to override the disabling of the audio component.

13. The audio device of claim 1 wherein the audio component is further configured to:
convert the audio signal into the frequency domain;
apply information representative of the headphone's response to the frequency domain audio signal;
apply a weighting curve to the frequency domain audio signal;
integrate the frequency domain audio signal over frequency to produce a signal representative of the total instantaneous acoustic energy; and
integrate the signal representative of the total instantaneous acoustic energy over time to produce the determined equivalent sound level.

14. An audio device, comprising:
means for providing an audio signal to headphones;
means for determining an equivalent sound level of the audio signal; and
means for attenuating the audio signal to limit acoustic energy output from the headphones based on the determined equivalent sound level.

15. The audio device of claim 14 further comprising means for adjusting the volume of the audio signal, wherein the means for attenuating the audio signal is configured to attenuate the audio signal by adjusting gain of the volume controller.

16. The audio device of claim 14 wherein the means for determining the equivalent sound level is configured to determine the equivalent sound level using information representative of the headphone's response.

17. The audio device of claim 16 wherein the means for determining the equivalent sound level is further configured to determine the equivalent sound level by applying the information to the audio signal.

18. The audio device of claim 16 further comprising means for providing the information to the means for determining the equivalent sound level.

19. The audio device of claim 16 further comprising means for requesting the information from the headphones.

20. The audio device of claim 16 further comprising means for receiving the information from the headphones and providing the information to the means for determining the equivalent sound level.

21. The audio device of claim 14 further comprising the headphones.

22. The audio device of claim 14 wherein the means for determining the equivalent sound level is further configured to determine the equivalent sound level by applying a weighting curve to the audio signal.

23. The audio device of claim 14 further comprising means for alerting a user if the determined equivalent sound level exceeds a threshold.

24. The audio device of claim 14 further comprising means for disabling the means for determining the equivalent sound level.

25. The audio device of claim 24 further comprising means for overriding the means for disabling the means for determining the equivalent sound level.

26. The audio device of claim 14 wherein the means for determining the equivalent sound level further comprises:
means for converting the audio signal into the frequency domain;
means for applying information representative of the headphone's response to the frequency domain audio signal;
means for applying a weighting curve to the frequency domain audio signal;
means for integrating the frequency domain audio signal over frequency to produce a signal representative of the total instantaneous acoustic energy; and
means for integrating the signal representative of the total instantaneous acoustic energy over time to produce the determined equivalent sound level.

27. A machine-readable medium comprising instructions executable by a processor, the instructions comprising code for:
providing an audio signal to headphones;
determining an equivalent sound level of the audio signal; and
attenuating the audio signal to limit acoustic energy output from the headphones based on the determined equivalent sound level.

28. The machine-readable medium of claim 27 wherein the instructions further comprises code for adjusting the volume of the audio signal, wherein the code for attenuating the audio signal is configured to attenuate the audio signal by adjusting gain of the volume controller.

29. The machine-readable medium of claim 27 wherein the code for determining the equivalent sound level is configured to determine the equivalent sound level using information representative of the headphone's response.

30. The machine-readable medium of claim 29 wherein the instructions further comprises code for requesting the information from the headphones.

31. The machine-readable medium of claim 29 wherein the instructions further comprises code for receiving the information from the headphones and providing the information to the means for determining the equivalent sound level.

32. The machine-readable medium of claim 27 wherein the instructions further comprises code for determining the equivalent sound level further comprises code for:
converting the audio signal into the frequency domain;
applying information representative of the headphone's response to the frequency domain audio signal;
applying a weighting curve to the frequency domain audio signal;
integrating the frequency domain audio signal over frequency to produce a signal representative of the total instantaneous acoustic energy; and
integrating the signal representative of the total instantaneous acoustic energy over time to produce the determined equivalent sound level.
